(19) United States
(12) Patent Application Publication
(10) Pub. No.: US 2026/0360882 A1
(43) Pub. Date: Nov. 12, 2026

(54) CYLINDRICAL BATTERY CELL COMPRISING A LID CLOSURE

(71) Applicant: Northvolt AB, Stockholm (SE)

(72) Inventor: Kelvin Yuen, Västerås (SE)

(21) Appl. No.: 19/142,044

(22) PCT Filed: Dec. 20, 2023
(86) PCT No.: PCT/EP2023/086989

§ 371 Date: Jun. 20, 2025

(30) Foreign Application Priority Data
Dec. 23, 2022 (SE) 2251575-3
Aug. 31, 2023 (SE) 2351026-6

(51) Int. Cl. H01M 50/169; B60L 50/64; H01M 10/0587; H01M 50/107; H01M 50/152; H01M 50/536

(52) U.S. Cl. CPC H01M 50/169; H01M 10/0587; H01M 50/107; H01M 50/152; H01M 50/536; B60L 50/64; H01M 2220/20

(57) ABSTRACT

A cylindrical battery cell (100) is provided. The cylindrical battery cell comprises a cylindrical can (107) for housing an electrode roll (106), the cylindrical can comprising a beading groove (110) formed in a wall of the cylindrical can and arranged around the circumference of the cylindrical and a clamping portion (111) between the beading groove and the edge of the cylindrical can, and a lid (130) configured to close an open end of the cylindrical can. The lid is arranged to form an electrical connection from the electrode roll to the cylindrical can, by electrical contact of the lid with the can at the clamping portion.

### TECHNICAL FIELD

The present disclosure relates to a cylindrical battery cell comprising a lid, and a method of manufacturing such a cylindrical battery cell.

### BACKGROUND

In addressing climate change, there is an increasing demand for rechargeable batteries, e.g., to enable electrification of transportation and to supplement renewable energy. Currently, lithium-ion batteries are becoming increasingly popular. They represent a type of rechargeable battery in which lithium ions move from the negative electrode to the positive electrode during discharge and back when charging.

As the demand for rechargeable batteries increases, more and more focus is being placed on production speed and cost. To achieve an effective production of rechargeable batteries, the design of the batteries as well as their manufacturing process can be optimized.

### SUMMARY

The present disclosure aims to provide improved cylindrical battery cells and parts thereof. The improvements may be in energy performance, manufacturing efficiency, and assembly simplification, among others. More specifically, this disclosure relates to the closing of a cylindrical can of a cylindrical battery cell comprising a lid.

In particular, according to an aspect of the present disclosure, there is provided a cylindrical battery cell. The cylindrical battery cell comprises a cylindrical can for housing an electrode roll. The cylindrical can comprises a beading groove formed in a wall of the cylindrical can and arranged around the circumference of the cylindrical and a clamping portion between the beading groove and the edge of the cylindrical can. The cylindrical battery cell further comprises a lid configured to close an open end of the cylindrical can. The lid is arranged to form an electrical connection from the electrode roll to the cylindrical can, by electrical contact of the lid with the can at the clamping portion.

In this way, the lid may form part of a terminal of the cylindrical battery cell.

In battery cells of the prior art, the lid may be wrapped in a gasket to electrically isolate the lid. In the present disclosure, the need for a gasket wrapping the lid is reduced. This may provide for use of less material when manufacturing the cylindrical battery cell and an easier assembly of the cylindrical battery cell, as well as a greater flexibility in respect of how to electrically connect the cell to a load (e.g., via the lid). Further, the need for preassembly of the lid and gasket before assembly of the battery cell may be decreased, which allows for an easier manufacturing process

In an example embodiment, the lid is in direct electrical contact with the can at the clamping portion. By having the lid in direct electrical contact with the can at the clamping portion, the lid may form part of an electrical terminal of the cylindrical battery cell. Further, this decreases the need for components connecting the lid and a terminal of the battery (e.g., a current collector), allowing for use of less materials in the manufacturing of the battery cell.

In an example embodiment, the lid and the clamping portion form a hermetic seal of the cylindrical can. In other words, an opening of the can at the clamping portion may be sealed in a substantially fluid-tight or gas-tight manner. In this way, liquid stored in the cylindrical battery cell may be prevented from leaking out of the can.

In an example embodiment, the lid is welded to the clamping portion. By welding the lid to the clamping portion, a reliable electrical and mechanical connection may be formed therebetween.

In some examples, the lid may be laser welded, resistance welded, ultrasonically welded, or soldered to the clamping portion. By welding the lid to the clamping portion, a hermetic seal or a substantially fluid-tight seal or gas-tight may be achieved.

In an example embodiment, the cylindrical battery cell further comprises at least one gasket arranged around the opening of the can at the clamping portion so as to form a hermetic seal of the can. By using a gasket, a hermetic seal of the can may be achieved in a manner that is reliable and well understood in the art, without the need for welding the lid to the can. The gasket may thus act as a sealing component of the closure of the can by the lid and the clamping portion.

In an example embodiment, the cylindrical battery cell further comprises a current collector connected to the electrode roll, wherein the current collector is in direct electrical contact with the lid and/or the cylindrical can. The current collector may in some examples be a current collector disc.

In an example embodiment, the current collector and the lid are clamped at the clamping portion so as to form the hermetic seal. By clamping it may be meant compressing or crimping.

In an example embodiment, the at least one gasket is arranged at at least one of: between the electrical can and the lid at a top end of the clamping portion; between the electrical can and the lid at a bottom end of the clamping portion; and between the current collector and the can. In this example, the lid does not necessarily need to be wrapped by a gasket, as in the prior art.

In an example embodiment, the lid is in direct contact with the can and the lid is not in direct contact with the current collector. In some examples there is arranged a gasket between the lid and the current collector.

According to a further aspect of the present disclosure, there is provided a method for manufacturing the cylindrical battery cell according to any embodiment described herein. The method comprises arranging a lid at the clamping portion, and sealing the can at the clamping portion such that a hermetic seal is created by the can and the lid.

In an example embodiment, the sealing comprises compressing the clamping portion; or welding the clamping portion to the lid. In this way, a hermetic seal of the can of the cylindrical battery cell may be achieved. Further, this provides for forming a reliable electrical and mechanical connection between the lid and the can.

In preferred examples, when using welding, the welding means is directed from an outside of the cell, i.e., directed at the lid from an outside. Thereby, a manufacture of the secondary cell is greatly simplified and ejecta resulting from such welding are advantageously kept from contaminating an internal of the cell.

In an example embodiment, the method further comprises arranging a current collector against the portion of the electrode roll and at a clamping portion.

In an example embodiment, the method further comprises arranging at least one gasket between the lid and the cylindrical can and/or between the current collector and the cylindrical can.

According to a further aspect of the present disclosure, there is provided a battery system comprising a plurality of battery cells according to any embodiment described herein. The battery cells may be interconnected.

According to a further aspect of the present disclosure, there is provided a vehicle comprising a cylindrical battery cell according to any embodiment described herein, and/or comprising a battery system according to any embodiment described herein.

Accordingly, aspects of the present disclosure provide improvements in energy performance, manufacturing efficiency, and assembly simplification, for terminal rivets and the cylindrical secondary cells in which they are installed, among other advantages which will be made clear through the below description of specific embodiments.

### BRIEF DESCRIPTION OF THE DRAWINGS

One or more embodiments of the present disclosure will be described, by way of example only, and with reference to the following figures, in which:

FIG. 1 schematically shows a cross-sectional side view of a cylindrical secondary cell according to aspects of the present disclosure;

FIGS. 2A, 2B, 2C, 2D, 2E, 2F schematically show alternative examples for closing the can using at least one gasket, according to aspects of the present disclosure;

FIGS. 3A, 3B and 3C schematically show alternative examples for closing the can when the lid is welded to the can, according to aspects of the present disclosure;

FIG. 4 illustrates a method of manufacturing a cylindrical battery cell, according to aspects of the present disclosure.

FIG. 5 shows a perspective view of a battery pack according to an aspect of the present disclosure.

FIG. 6 schematically shows an example vehicle comprising the battery pack shown in FIG. 5.

### DETAILED DESCRIPTION

The present disclosure is described in the following by way of a number of illustrative examples. It will be appreciated that these examples are provided for illustration and explanation only and are not intended to be limiting on the scope of the present disclosure. Instead, the scope of the present disclosure is defined by the appended claims.

Furthermore, although embodiments be presented individually for the sake of focused discussion of particular features, it will be recognized that the present disclosure also encompasses combinations of the embodiments described herein.

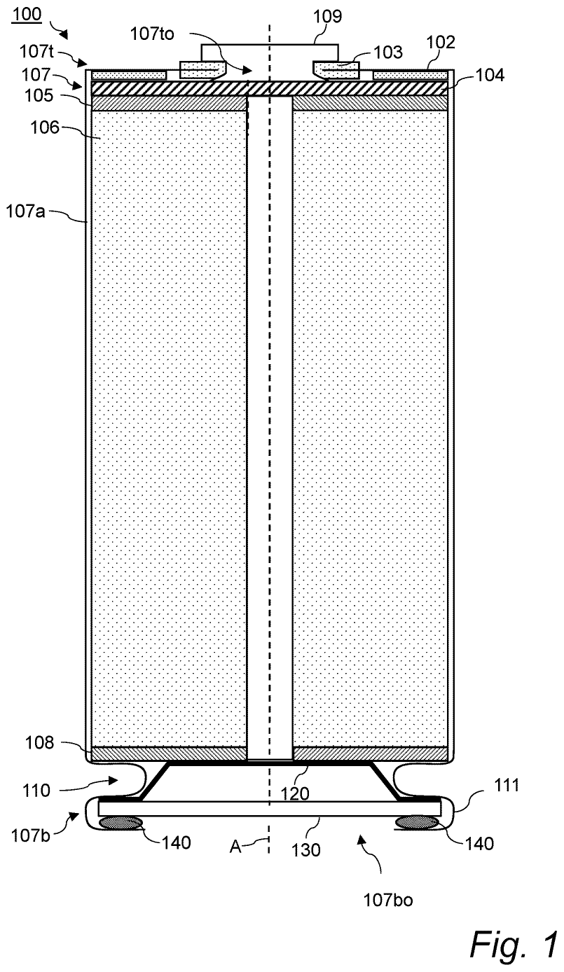

FIG. 1 schematically shows a cross-sectional view of a cylindrical battery cell 100 comprising a lid 120 in a bottom opening 107bo of a cylindrical casing 107. The cylindrical battery cell 100 (also referred to as simply the ‘cell 100’) comprises an electrode roll 106 housed in the cylindrical casing 107.

The cylindrical casing 107 extends along an axis A between a first end 107t, which may be referred to as a ‘top end’ 107t, and an open bottom end 107b which is closed by a lid 130. As used herein, the labels ‘top’ and ‘bottom’ are purely to aid in understanding the figures and not intended to suggest any preferred orientation for the cell 100. The casing 107 further comprises a curved side wall 107a and a beading groove 110 formed in the side wall 107a. Between the beading groove 110 and the edge of the side wall 107a towards the bottom end 107b, a clamping portion 111 is formed, wherein a gasket 140 is arranged around the can 107 at the clamping portion 111 to thereby seal the bottom end opening 107bo of the casing 107. It will be appreciated that the clamping portion 111 is substantially comprised between the beading groove 110 and the lip at the edge of the can 107 such that the formation of the beading groove 110 at least partially forms the clamping portion 111.

The electrode roll 106 may be formed of an anode sheet, a cathode sheet, and a separator sheet arranged therebetween to thereby enable a storage of electrical energy. Cathode tabs 105 may extend from a first end of the electrode roll 106 and anode tabs 108 may extend from the other end, or vice versa. The cathode tabs 105 and anode tabs 108 may provide connective surfaces to which current collecting plates 104, 130 can be connected. The battery cell further comprises a rivet 109 extending through an opening 107to in the casing 107.

A cathode current collector 104, which in some examples is or comprises a current collector plate, is arranged in direct electrical contact with the cathode tabs 105 and an anode current collector 120, which may be or comprise a current collector plate, is arranged in direct electrical contact with the anode tabs 108. Here, the labels ‘cathode’ and ‘anode’ may be swapped. Thus, an electrical connection is formed from the cathode tabs 105 to the rivet 109, as the rivet 109 is connected to the current collecting plate 104. An electrical connection is also formed from the anode tabs 108 to the casing 107 and to the lid 130, as the current collecting plate 120 is arranged in connection with the casing 107 and the lid 130 at the clamping portion 111.

Thus, it can be seen that the exposed head of the terminal rivet 109 serves as an external terminal of the cell 100, this being a positive terminal in this example, and the casing 107 and the lid 130 serves as the negative terminal. Hence, it is seen that both terminals of the cell 100 are accessible at the same side. The top end 107t of the casing 107 comprises a first electrical contact surface extending in a first plane, and the head of the rivet 109 comprises a second electrical contact surface, extending in a second plane axially spaced from the first plane.

Further details of the closing of the bottom portion 170b of the cylindrical can 107 using a lid 130 will now be described.

The lid 130 and the clamping portion 111 are arranged so as to form a hermetic seal of the cylindrical can 107. The hermetic seal prevents any liquid from exiting the can 107 at the bottom end 107b through the bottom end opening 107bo.

The lid 130 is further arranged to form an electrical connection from the electrode roll 106 to the cylindrical can 107, by electrical contact of the lid 130 with the can at the clamping portion 111. As the lid 130 is in direct contact with the current collector, the lid forms part of the negative terminal of the cell.

In the example shown in FIG. 1, the lid 130 is arranged in direct contact with the can 107 at the clamping portion 111. That is, the lid 130 is in direct physical contact with the can 107, without any gasket 140 or other insulating material arranged between at least a portion of the lid 130 and a portion of the clamping portion 111.

The hermetic seal may be achieved by, for example, the use of a gasket 140 to seal the opening between the lid 130 and the can 107, or by welding the lid 130 to the can 107 at the clamping portion 111. When the lid 130 is welded to the can 107 the use of a gasket 140 is optional.

In the example shown in FIG. 1, the can 107 is closed by a lid 130 and a gasket 140 arranged around the bottom opening 107bo at the clamping portion 111. The lid 130, the clamping portion 111 and the gasket 140 may be clamped or compressed together so as to form the hermetic seal.

As described above, the gasket 140 may, when clamped with the lid 130 at the clamping portion 111, form a hermetic seal.

The gasket 140 may be formed of a polymer having elastic, resilient, and electrically insulating properties, such as PFA. The gasket 140 may have the same properties as the gasket 103, as described below.

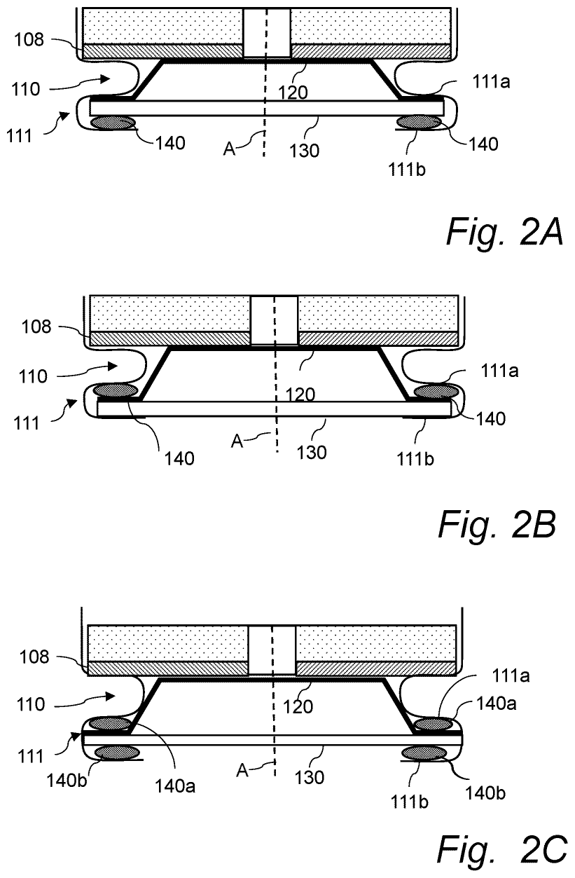

More configurations of the lid 130, the current collector 120, the clamping portion 111 and any gasket 140 will be described with reference to FIGS. 2A-2F.

Now the top portion of the cell 100 will be described.

Arranged around the terminal rivet 109 is a gasket 103 configured to form a fluid-tight seal or a gas-tight for the opening 107to in the top end 107t of the casing 107. The gasket 103 is arranged at least around the shaft of the rivet 109. The gasket 103 further extends between the head of the rivet 109 and the top end 107t of the casing 107 so as to electrically isolate the opposite terminals of the cell 100 from each other. Thus, it can be seen that gasket 103 serves multiple purposes. The gasket 103 may be preferably formed of a polymer having elastic, resilient, and electrically insulating properties, such as PBT, PPS, or the like. In preferred examples, including that illustrated in FIG. 1, the gasket 103 extends between the head of the rivet 109 and the casing 107, radially beyond the head of the rivet 109.

In some examples, the gasket 103 may be formed of separate parts, each part being specifically configured for a respective purpose. For example, for the part(s) of the gasket 103 around the opening 107to and intended to seal the opening 107to, the gasket 103 may be formed of one material such as PFA. For the part(s) of the gasket 103 between the head of the rivet 109 and the casing 107 and intended to electrically isolate these components from each other, the gasket 103 may be formed from another material such as a PPS polymer.

FIGS. 2A, 2B, 2C, 2D, 2E, 2F schematically show alternative examples for closing the can using at least one gasket, according to aspects of the present disclosure.

FIG. 2A shown the same example of closing the can as discussed with reference to FIG. 1. In this example, the can 107 is closed by clamping a current collector 120, a lid 130, and a gasket in the clamping portion 111 of the can 107. The lid is in direct electrical contact with both the current collector 120 and the can 107 at the clamping portion 111. The gasket is arranged at an bottom most end of the clamping portion 111, between the clamping portion 111 and the lid 130, for providing a hermetic seal of the can.

In other words, as shown in FIG. 2A, the components used to close the can may be arranged in the following order in the clamping portion, from the bottom: a first portion 111b of the clamping portion 111, the gasket 140, the lid 130, the current connector 120 and a second portion 111a of the clamping portion 111.

FIG. 2B shows an alternative example for closing the can 107. In this example, the can 107 is closed by clamping a gasket 140, a current collector 120, and a lid 130 in the clamping portion 111 of the can 107. The lid 130 is in direct electrical contact with both the current collector 120 and the can 107 at the clamping portion 111. The gasket 140 is arranged at an topmost end of the clamping portion 111, at a portion of the beading groove 110, between the clamping portion 111 and the current collector 120, for providing a hermetic seal of the can 107.

A shown in FIG. 2B, the components used to close the can may be arranged in the following order in the clamping portion, from the bottom: a first portion 111b of the clamping portion 111, the lid 130, the current connector 120, the gasket 140 and a second portion 111a of the clamping portion 111.

FIG. 2C shows another alternative example for closing the can 107. In this example, two gaskets 140a, 140b are used. The first gasket 140a is arranged around the can 107 at top end 111a of the clamping portion 111. The second gasket is arranged around the can 107 at a bottom end 111b of the clamping portion 111. The lid 130 and the current collector are arranged between the first gasket 140a and the second gasket 140b. The lid 130 is in direct electrical contact with the can 107 at the clamping portion 111 between the first gasket 140a and the second gasket 140b. The lid 130 is also in direct electrical contact with the current collector 120.

As shown in FIG. 2C, the components used to close the can may be arranged in the following order in the clamping portion 111, from the bottom: a first portion 111b of the clamping portion 111, a second gasket 140b, the lid 130, the current connector 120, the first gasket 140a and a second portion 111a of the clamping portion 111.

FIGS. 2D-2F show alternative examples for closing the can 107. In these examples, the lid 131 is in direct electrical contact with the electrode roll 106 at electrode tabs 108, so as to provide an electrical connection between the electrode roll 106 and the can 107. Thus, there is no current collector separate from the lid 131.

In the example illustrated in FIG. 2D, the lid 131 and a gasket 140 are arranged in the clamping portion to create a hermetic seal. The lid 131 is in direct electrical contact with the can 107. As can be seen from FIGS. 2D and 2E, the gasket 140 may be arranged at either side of the lid 131 at the clamping portion. In other words, the gasket 140 may arranged around the can 107 at top end 111a of the clamping portion 111, or the gasket 140 may be arranged around the can 107 at a bottom end 111b of the clamping portion.

In other words, as shown in FIG. 2D, the components used to close the can may be arranged in the following order in the clamping portion 111, from the bottom: a first portion 111b of the clamping portion 111, a gasket 140, the lid 131, and a second portion 111a of the clamping portion 111. In this example, the lid 131 may act as a current collector.

As shown in FIG. 2E, the components used to close the can may be arranged in the following order in the clamping portion 111, from the bottom: a first portion 111b of the clamping portion 111, the lid 131, a gasket 140, and a second portion 111a of the clamping portion 111. In this example, the lid 131 may act as a current collector.

FIG. 2F shows another alternative example for closing the can 107. In this example, two gaskets 140a, 140b are used. The first gasket 140a is arranged around the can 107 at top end 111a of the clamping portion 111. The second gasket is arranged around the can 107 at a bottom end 111b of the clamping portion 111. The lid 131 is arranged between the first gasket 140a and the second gasket 140b. The lid 131 is in direct electrical contact with the can 107 at the clamping portion 111 between the first gasket 140a and the second gasket 140b. Thus, the lid 131 extends all the way to the clamping portion 111.

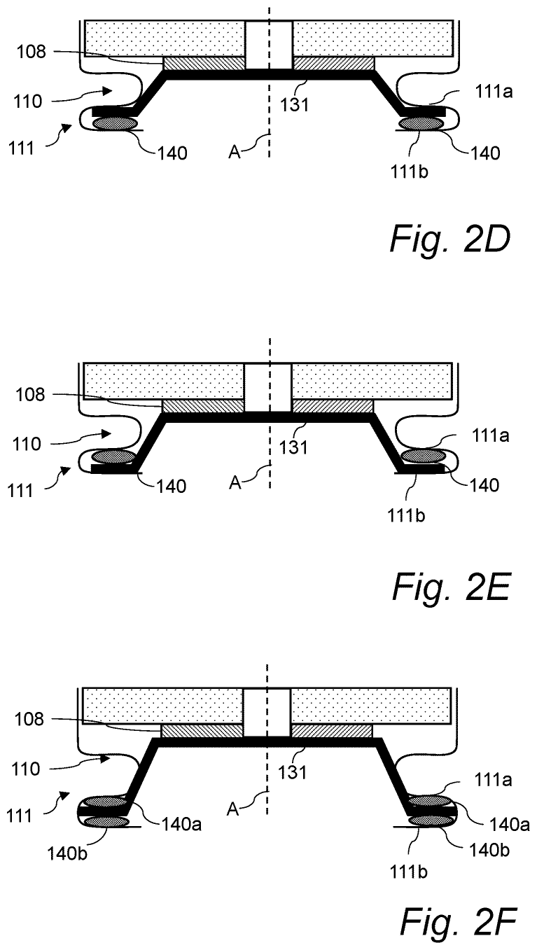

In other words, as shown in FIG. 2F, the components used to close the can may be arranged in the following order in the clamping portion 111, from the bottom: a first portion 111b of the clamping portion 111, a second gasket 140b, the lid 131, a first gasket 140a, and a second portion 111a of the clamping portion 111. FIGS. 3A, 3B and 3C schematically show alternative examples for closing the can when the lid is welded to the can, according to aspects of the present disclosure. When the lid 130 is welded to the can 107, a hermetic seal of the can 107 may be achieved without the need for a gasket 140.

FIG. 3A show an example where a current collector 120 and a lid 130 are arranged at the clamping portion 111 of the can 107. The clamping portion is arranged at a surface of the lid 130 such that the clamping portion 111 may be welded to the lid 130 to form a hermetic seal. The clamping portion 111 and the lid 130 may be welded together at a peripherally radial portion of the lid 130.

As shown in FIG. 3A, the components used to close the can may be arranged in the following order in the clamping portion 111, from the bottom: a first portion 111b of the clamping portion 111, the lid 130, a current collector 120, and a second portion 111a of the clamping portion 111. In preferred embodiments, the edge of the casing, corresponding to the first portion 111b of the clamping portion 111, extends radially inwards to overlap the lid by an amount that facilitates a reliable weld therebetween.

In the example shown in FIG. 3B, the lid 131 is attached to the can 107 in the same way as described with reference to FIG. 3A. The difference between the example shown in FIG. 3A and the example shown in FIG. 3B is that in 3B the lid 131 is in direct electrical contact with the electrode roll 106 at electrode tabs 108, so as to provide an electrical connection between the electrode roll 106 and the can 107. Thus, there is no current collector separate from the lid 131.

As shown in FIG. 3B, the components used to close the can may be arranged in the following order in the clamping portion 111, from the bottom: a first portion 111b of the clamping portion 111, the lid 130, and a second portion 111a of the clamping portion 111.

As shown in FIG. 3C, the lid 131 is attached to the can 107 in the same way as described with reference to FIG. 3B. In this example, the lid 131 may be substantially flat, for example, in the form of a disc. The electrode tabs 108 thus extends from the electrode roll to the 131 to be in electrical contact with the lid 131.

As shown in FIG. 3B, the components used to close the can may be arranged in the following order in the clamping portion 111, from the bottom: a first portion 111b of the clamping portion 111, the lid 130, and a second portion 111a of the clamping portion 111.

In the examples shown in FIGS. 3A, 3B and 3C the lid 131, 130 may be welded to the can 107 to thereby form a reliable electrical and mechanical connection therebetween. Such welding (or soldering) may be performed by any suitable means such as a welding laser, ultrasonic welding, capacitor discharge welding, or the like.

The closure shown in FIG. 3C may alternatively be used with a gasket, as shown in any of FIG. 2D, 2E or 2F. In those examples, the can 107 may be closed by compressing the lid, a gasket and the clamping portion together so as to form a fluid-tight or gas-tight seal, as described with reference to FIGS. 2D, 2E, and 2F.

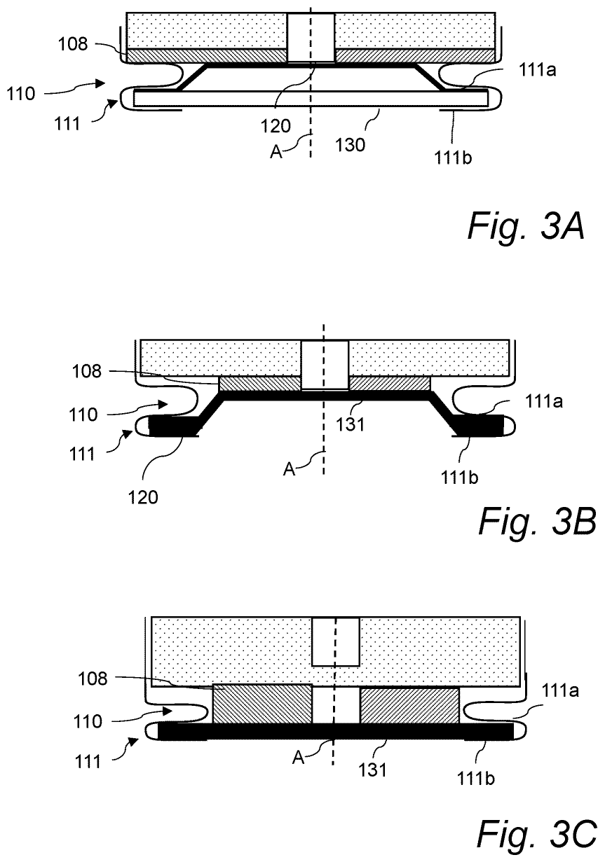

FIG. 4 illustrates a method of manufacturing a cylindrical battery cell, according to aspects of the present disclosure. Optional steps are indicated by dashed lines in the figure.

FIG. 4 illustrates a method for manufacturing the cylindrical battery cell according to any example or embodiment described herein. The method comprises arranging 420 a lid at a clamping portion of a can, and sealing 430 the can at the clamping portion such that a hermetic seal is created by the can and the lid.

The sealing may comprise compressing (which may also be referred to as ‘clamping’ or ‘crimping’) the clamping portion. When compressing the clamping portion to create a seal, the lid 130, 131, optionally a gasket 140 and optionally the current collector 120 may be arranged in the clamping portion at the beading groove 110. After the lid 130, 131 and any current collector 120 has been arranged the clamping portion 111 may be wrapped around them, as shown in any of FIGS. 2A-F and 3A-B. The clamping portion 111 may then be compressed so as to form a hermetic seal of the can 107.

The sealing may comprise welding the clamping portion 111 to the lid 130, 131. Such welding (or soldering) may be performed by any suitable means such as a welding laser, ultrasonic welding, capacitor discharge welding, or the like.

The method may further comprise arranging 410 a current collector 120 against the portion of the electrode roll and at the clamping portion.

The method may further comprise arranging 440 at least one gasket 140 between the lid 130, 131 and the cylindrical can 107 and/or between the current collector 120 and the cylindrical can 107. This step is preferably used when the method comprises the step of compressing the clamping portion 111. As can be seen from some examples of closing the can described above with references to FIGS. 2A-F and FIGS. 3A-C, the method may comprise arranging a first gasket 140a between the lid 130, 131 and the cylindrical can 107 at the clamping portion 111 and arranging a second gasket 140b between the current collector 120 and the cylindrical can 107 at the clamping portion 111, or the method may comprise arranging a first gasket 140a between the lid 130, 131 and the cylindrical can 107 at a first side of the lid 130, 131 and arranging a second gasket 140b between the lid 130, 131 and the current collector 120 at a second side of the lid 130, 131.

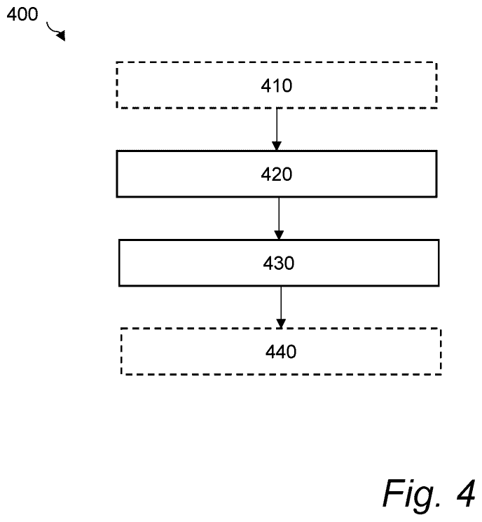

FIG. 5 shows a perspective view of a battery pack 500 with a portion of its casing (being illustrated in a purely schematic way) cut away to schematically show a plurality of cylindrical battery cells 100 housed therein. The cylindrical battery cells 100 may correspond to the cylindrical battery cells 100 described above.

The battery cells 100 are connected together in series and/or parallel, and in an optionally modular fashion, so as to form a combined electrical storage capacity. In some examples, the cells have a common orientation such that failure vents of the cells are oriented in a same direction, and such that the terminals of the cells can be accessed at a same side.

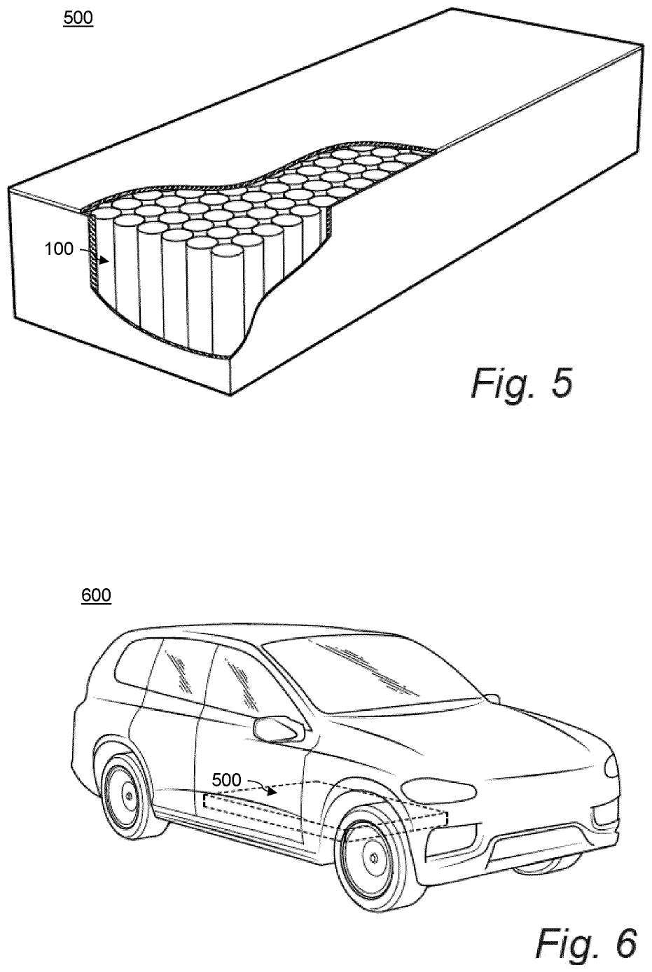

FIG. 6 schematically shows an example vehicle 600 comprising the battery pack 500 shown in FIG. 5. In this example, the battery pack is arranged at a lower portion of the vehicle 600, which may be an electric or hybrid vehicle. Other uses for the battery pack 600 may comprise a standalone battery pack for powering devices or installations or the like.

It will be appreciated that the advantages described above conferred to the battery cells according to aspects of the present disclosure, will also be conferred to a battery pack comprising said cells, and any vehicle comprise such a battery pack. Thus, these advantages are not discussed in detail again.

While the present disclosure is susceptible to various modifications and alternative forms, specific embodiments are shown and described above by way of example in relation to the drawings, with a view to clearly explaining the various advantageous aspects of the present disclosure. It should be understood, however, that the detailed description herein and the drawings attached hereto are not intended to limit the disclosure to the particular form disclosed. Rather, the intention is to cover all modifications, equivalents, and alternatives falling within the scope of the following claims.

1. A cylindrical battery cell (100) comprising:
a cylindrical can (107) for housing an electrode roll (106), the cylindrical can comprising a beading groove (110) formed in a wall of the cylindrical can and arranged around the circumference of the cylindrical and a clamping portion (111) between the beading groove and the edge of the cylindrical can, and
a lid (130) configured to close an open end of the cylindrical can,
wherein the lid is arranged to form an electrical connection from the electrode roll to the cylindrical can, by electrical contact of the lid with the can at the clamping portion.

2. The cylindrical battery cell according to claim 1, wherein the lid is in direct electrical contact with the can at the clamping portion.

3. The cylindrical battery cell according to claim 1, wherein the lid and the clamping portion form a hermetic seal of the cylindrical can.

4. The cylindrical battery cell according to claim 1, wherein the lid is welded to the clamping portion.

5. The cylindrical battery cell according to claim 4, wherein the lid is laser welded, resistance welded, ultrasonically welded, or soldered to the clamping portion.

6. The cylindrical battery cell according to claim 1, further comprising at least one gasket (140) arranged around the opening of the can at the clamping portion so as to form a hermetic seal of the cylindrical can.

7. The cylindrical battery cell according to claim 1, further comprising a current collector (120) connected to the electrode roll, wherein the current collector is in direct electrical contact with the lid and/or the cylindrical can.

8. The cylindrical battery cell according to claim 6, wherein the current collector and the lid are clamped at the clamping portion so as to form the hermetic seal.

9. The cylindrical battery cell according to claim 6, wherein the at least one gasket is arranged at at least one of:
between the electrical can and the lid at a top end of the clamping portion;
between the electrical can and the lid at a bottom end of the clamping portion; or
between the current collector and the can.

10. The cylindrical battery cell according to claim 1, wherein the lid is in direct contact with the can and wherein the lid is not in direct contact with the current collector.

11. A method for manufacturing the cylindrical battery cell according to claim 1, the method comprising:
arranging (420) the lid at the clamping portion, and
sealing (430) the can at the clamping portion such that a hermetic seal is created by the can and the lid.

12. The method according to claim 11, wherein sealing comprises:
compressing the clamping portion; or
welding the clamping portion to the lid.

13. The method according to claim 11, further comprising:
arranging (410) the current collector against the portion of the electrode roll and at the clamping portion.

14. The method according to claim 11, further comprising:
arranging (440) at least one gasket between the lid and the cylindrical can and/or between the current collector and the cylindrical can.
